(19) United States
(12) Patent Application Publication
(10) Pub. No.: US 2018/0007471 A1
(43) Pub. Date: Jan. 4, 2018

(54) Electrodynamic Transducer in Ultrasonic Mode

(71) Applicant: Sound Solutions International Co., Ltd., Beijing (CN)

(72) Inventors: Christian Lembacher, Gramatneusiedl (AT); Friedrich Reining, Vienna (AT); Markus Flock, Vienna (AT); Armin Timmerer, Vienna (AT); Christian Klaubauf, Vienna (AT); Heribert Bauer, Siegendorf (AT); Stefan Zangl, Vienna (AT); Andreas Hintennach, Vienna (AT)

(21) Appl. No.: 15/545,625

(22) PCT Filed: Feb. 11, 2016
(86) PCT No.: PCT/MY2016/050008

§ 371 Date: Jul. 21, 2017

Related U.S. Application Data
(60) Provisional application No. 62/114,580, filed on Feb. 11, 2015.

(51) Int. Cl. H04R 9/06; H04R 9/02; H04R 7/18; H04R 7/04; H04R 31/00; H04R 1/28

(52) U.S. Cl. CPC H04R 9/06; H04R 31/006; H04R 31/003; H04R 1/2803; H04R 7/18; H04R 7/04; H04R 9/025

(57) ABSTRACT

An electrodynamic transducer having a coil, a membrane, and a plate is disclosed, wherein the transducer is adapted to generate a sound pressure level in the human-audible acoustic range and the ultrasonic range so that the transducer may be used as a speaker and an ultrasonic proximity sensor. The transducer may be adapted to generate a sound pressure level above about 88 dB between 20 kHz and 70 kHz. The plate may include a structural rigidity increasing feature such as a domed portion or a population of ribs, which may increase the generated sound pressure level in the ultrasonic range. The transducer may also include a front resonator which may be used to further tune and/or increase the generated sound pressure level in the ultrasonic range.

### BACKGROUND OF THE INVENTION

### a. Field of the Invention

This invention relates to electrodynamic transducers, particularly transducers used as loudspeakers and capable of sound transmission in the audible and ultrasonic frequency ranges. The invention further relates to a proximity sensor system that utilizes a speaker capable of sound transmission in the audible and ultrasonic frequency ranges and a microphone capable of receiving voice signals and ultrasonic frequency signals. The invention further relates to a mobile telephone incorporating such a proximity sensor.

### b. Background Art

While the size of mobile phones has gotten smaller and/or thinner, the demand for more features and capabilities has only increased. The components needed for all the new features and capabilities, however, require more and more space within the phone housing. There has been a desire in the industry to shrink the size of the space required by various components. In some situations, the functions of two or more components have been combined into one component to reduce the required space.

Proximity sensing technology is popular across a wide range of industries, and are now frequently used in mobile phone for a variety of functions. For instance, proximity sensors can be used to detect when the phone is brought close to a user's ear. When the phone is in this position, it can turn off the display screen to reduce power consumption and disable the touch screen to avoid inadvertent touches by the cheek. Proximity sensors are also used to detect motion or movement near a phone so the phone can wake and display the user interface when a user's hand approaches the phone. This enables the device to operate in a low power, standby state when not in use and then wake-up into an active state upon approach, shortening wake-up times.

There are several types of proximity sensors, including inductive, capacitive photoelectric or opto-electronic and ultrasonic. Generally, the photoelectric principle is the most widely used, while the capacitive is the second most widely used for proximity detection purposes. Ultrasounds are used mainly for accurate range detection, and not for simple proximity detection.

An ultrasonic sensor generally comprises a transducer that can emit an acoustic wave beyond the upper range of human hearing—generally above 20 kilohertz—and a microphone that detects the echo of the wave after it bounces off an object. The sensor then determines the distance between the sensor and the object based on the time it takes to send the signal and receive the echo.

In a typical case where there is a desire for proximity detection in a mobile phone, a proximity sensor is required to be installed in the device. However, given the space constraints inside a mobile phone housing mentioned above and the ever increasing desire for smaller and fewer components, it would be beneficial to provide a method and a system for adding a proximity sensing functionality to a device, wherein no additional equipment or components are required.

U.S. Pat. No. 6,542,436 discloses a single speaker-single microphone detection arrangement for detecting if an object is in proximity to the device. Audio transducers already found in the device are used to realize the detection function. For the proximity sensing function, a measurement signal is generated for driving an output acoustic transducer of the device and an input acoustic transducer of the device is monitored to detect the measurement signal. The arrangement determines whether an object is in proximity to the device based on the detected alteration of the measurement signal.

However, the disclosed system utilizes a measurement signal within the audio range of human hearing. Ultrasonic sound attenuates much faster than audible sound when propagating through air, allowing for more accurate distance measurements. Thus, ultrasound waves are preferred for proximity detection purposes. Therefore, there is a need for an ultrasonic proximity sensor that utilizes the standard electrodynamic speaker and microphone found in a mobile phone.

### SUMMARY OF THE INVENTION

An aspect of the invention provides a electrodynamic transducer capable of functioning as a speaker and as an ultrasound signal transmitter for use in a mobile phone. Therefore, a mobile phone speaker may be used for the production of human-audible sound waves and for the production of ultrasonic sound waves. High sound pressure levels (SPL) in the ultrasonic range may be accomplished. For example, to enhance the frequency response in high frequencies (above about 20 kHz), the membrane of an electrodynamic transducer includes a soft suspension area and a stiff plate affixed thereto. The stiff plate may further include structural rigidity increasing elements, such as a domed portion or ribs. Therefore to achieve the desired SPL in the ultrasonic range, the following structural parameters of the electrodynamic transducer may be modified: plate structure/geometry (including any structural rigidity increasing elements, such as dome portions or ribs), plate material, plate to membrane adhesion, coil to membrane adhesion, and/or including of a membrane with additional resonator.

Additionally, an optimized mechanical integration of the electrodynamic transducer can further enhance the ultrasonic performance by including a front and/or rear resonator, which can also be part of mobile device. The front and/or rear resonator may be designed to increase the amplitude and Q factor, to accomplish the final tuning of the radiation behavior of the electrodynamic transducer, and to accomplish the final tuning of the frequency behavior of the electrodynamic transducer.

Therefore, the combination of several ultrasonic tuned resonators with resonators dedicated to the human-audible audio range may be realized in one combined area above the membrane.

Such electrodynamic transducers may be used with peak voltages far above the commonly used audio signals as long as the thermal limit of the transducer is not over traveled. This means that high crest factors can be used in order to generate high sound pressure level in the ultrasonic range for a short time.

Therefore as described herein a mobile telephone speaker may also be used as an ultrasound transducer for proximity sensing.

Thus, an aspect of the invention is directed to an electrodynamic transducer, comprising a coil, a membrane, and a plate, wherein the electrodynamic transducer is adapted to generate a sound pressure level in the human-audible acoustic range and the ultrasonic range.

Another aspect of the invention is directed to an electrodynamic transducer that may be adapted to generate a sound pressure level above about 88 dB between 20 kHz and 70 kHz.

Another aspect of the invention is directed to an electrodynamic transducer that may be adapted to generate a sound pressure level of between about 90 dB and 95 dB between 20 kHz and 70 kHz.

Another aspect of the invention is directed to an electrodynamic transducer wherein the plate comprises a structural rigidity increasing feature, such as a domed portion or population of ribs.

Yet another aspect of the invention is directed to an electrodynamic transducer further including a front resonator having one or more holes extending through the resonator, wherein the front resonator is adapted to increase the sound pressure level of the electrodynamic transducer in the ultrasonic range.

Yet another aspect of the invention is directed to an electrodynamic transducer comprising a coil, a plate, and a membrane. The plate includes a structural rigidity increasing feature, and the membrane includes an aperture within which the plate is located. The membrane and the plate partially overlap and the membrane and plate are adhered to one another at the partial overlap. The electrodynamic transducer is adapted to generate a sound pressure level in the human-audible acoustic range and the ultrasonic range.

Further details and advantages of such electrodynamic transducer will become apparent in the following description and the accompanying drawings.

### BRIEF DESCRIPTION OF THE DRAWINGS

These and other aspects, features, details, utilities, and advantages of the invention will become more fully apparent from the following detailed description, appended claims, and accompanying drawings, wherein the drawings illustrate features in accordance with exemplary embodiments of the invention, and wherein:

FIG. 1 shows a perspective section view of an electrodynamic transducer according to the first embodiment of the invention;

FIG. 2 shows a section view of the electrodynamic transducer of FIG. 1;

FIG. 3 shows a sectional diagram of the electrodynamic transducer of FIG. 1;

FIG. 4 shows a sectional diagram of an electrodynamic transducer according to the second embodiment of the invention;

FIG. 5 shows a frequency response of an electrodynamic transducer in the human-audible acoustic range according to the first embodiment of the invention;

FIG. 6 shows a frequency response of an electrodynamic transducer in the ultrasonic range according to the first embodiment of the invention;

FIG. 7 shows a perspective section view of an electrodynamic transducer according to the third embodiment of the invention;

FIG. 8 shows a section view of the electrodynamic transducer of FIG. 7;

FIGS. 9a through 9d show a perspective, top and section views of a plate with an ellipsoid shaped domed portion according to the third embodiment of the invention;

FIGS. 10a through 10d show perspective, top and section views of a plate with a torus shaped domed portion according to the third embodiment of the invention;

FIGS. 11a through 11c show perspective, top and section views of a plate with longitudinal ribs according to the third embodiment of the invention;

FIGS. 12a through 12c show perspective, top and section views of a plate with transverse ribs according to the third embodiment of the invention;

FIG. 13 shows a sectional diagram of an electrodynamic transducer according to the fourth embodiment of the invention;

FIG. 14 shows a perspective section view of a front resonator affixed to an electrodynamic transducer according to various embodiments of the invention;

FIG. 15a shows a frequency response of an electrodynamic transducer in the ultrasonic range without a front resonator according to various embodiments of the invention;

FIG. 15b shows a frequency response of an electrodynamic transducer in the ultrasonic range with a front resonator according to various embodiments of the invention;

FIG. 16 shows a sectional diagram of an electrodynamic transducer according to the first, second, third and fourth embodiments of the invention;

FIG. 17 shows a sectional diagram of an electrodynamic transducer according to the fifth embodiment of the invention;

FIG. 18 shows a theoretical frequency response of an electrodynamic transducer according to the fifth embodiment of the invention compared to a theoretical frequency response of an electrodynamic transducer according to any of the first through fourth embodiments of the invention; and

FIG. 19 shows a section view of a prior-art hi-fi speaker.

Like reference numbers refer to like or equivalent parts in the several views.

### DETAILED DESCRIPTION OF EMBODIMENTS

Various embodiments are described herein to various apparatuses. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” or “an embodiment,” or the like, means that a particular feature, structure, or characteristic described in connection with the embodiment is included in at least one embodiment. Thus, appearances of the phrases “in various embodiments,” “in some embodiments,” “in one embodiment,” or “in an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation given that such combination is not illogical or non-functional.

It must be noted that, as used in this specification and the appended claims, the singular forms “a,” “an” and “the” include plural referents unless the content clearly dictates otherwise.

The terms “first,” “second,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Furthermore, the terms “include,” “have,” and any variations thereof, are intended to cover a non-exclusive inclusion, such that a process, method, article, or apparatus that comprises a list of elements is not necessarily limited to those elements, but may include other elements not expressly listed or inherent to such process, method, article, or apparatus.

The terms “left,” “right,” “front,” “rear,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

All numbers expressing measurements and so forth used in the specification and claims are to be understood as being modified in all instances by the term “about.”

Described herein is an electrodynamic transducer which may be a high end miniature speaker specifically designed for mobile phones and smartphones where high quality voice transmission is required. The electrodynamic transducer is an ultrasonic frequency band transmission capable speaker, which can provide design feasibility to customers to use the speaker and a MEMS microphone solution to achieve proximity sensor and gesture control application without additional dedicated ultrasonic transducers or sensors. When used in a proximity sensor function, ultrasound has a clear advantage over other proximity sensors, in that its sensing capabilities are not affected by the color or material of the surface of the object being sensed.

In various embodiments the electrodynamic transducer may include, but is not limited to, the following features: (1) high sensitivity (71 dB/W/m); (2) ultrasonic capabilities between 20 kHz and 50 kHz; (3) additional dust protection meshes on rear of electrodynamic transducer; (4) 6 kHz peak optimized for extended range without additional resonators; (5) spring contacts for pick & place assembly; (6) compound membrane for minimum total harmonic distortion (THD), Q-factor and tumbling; and (7) 100% in-line measurement of all specified acoustical and electrical parameters.

The electrodynamic transducer is designed to translate electrical analog signals into audible and ultrasonic sound waves. The input signal is fed into a coil in a magnetic field, which is attached to a membrane. Through the principle of the electromagnetic force, the membrane is moved according to the contents of the input signal.

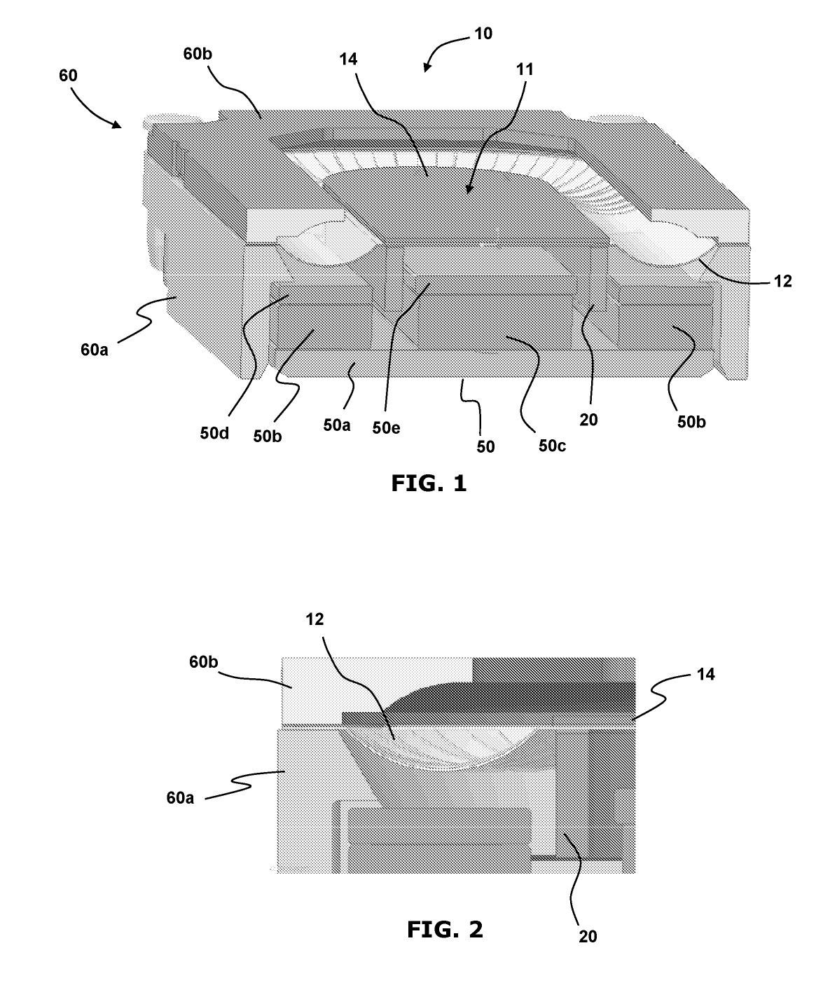

FIGS. 1 and 2 show perspective and section views, respectively, of the relevant parts of an electrodynamic transducer or micro speaker 10 which includes an ultrasonic mode. Speaker 10 comprises a membrane 12, a plate 14 to stiffen membrane 12, and a coil 20. An electrical signal to drive coil 20 in both the human-audible acoustic range and the ultrasonic acoustic range is fed into coil 20 through leads (not shown). Speaker 10 includes a magnet system 50 into which coil 20 is arranged in the assembled speaker 10. Speaker 10 further includes basket or membrane carrier 60 to assemble and align membrane 12 with a magnet system 50. In various embodiments, basket or membrane carrier 60 may include a bottom carrier portion 60a and a top carrier portion 60b. Magnet system 50 may include a bottom plate 50a, a population of magnets, such as perimeter magnets 50b around a center magnet 50c, each having top plates 50d, 50e, as is known in the art. Coil 20 fits into an air gap of magnet system 50 and is able to translate up and down within the air gap according to the electrical signal fed into coil 20 through leads.

Membrane 12, plate 14 and coil 20 are assembled in an assembly stack 11 in such a configuration to permit emission of sound waves from speaker 10 in the audible and ultrasonic ranges. As will be shown and described, various configurations of the assembly stack can be utilized.

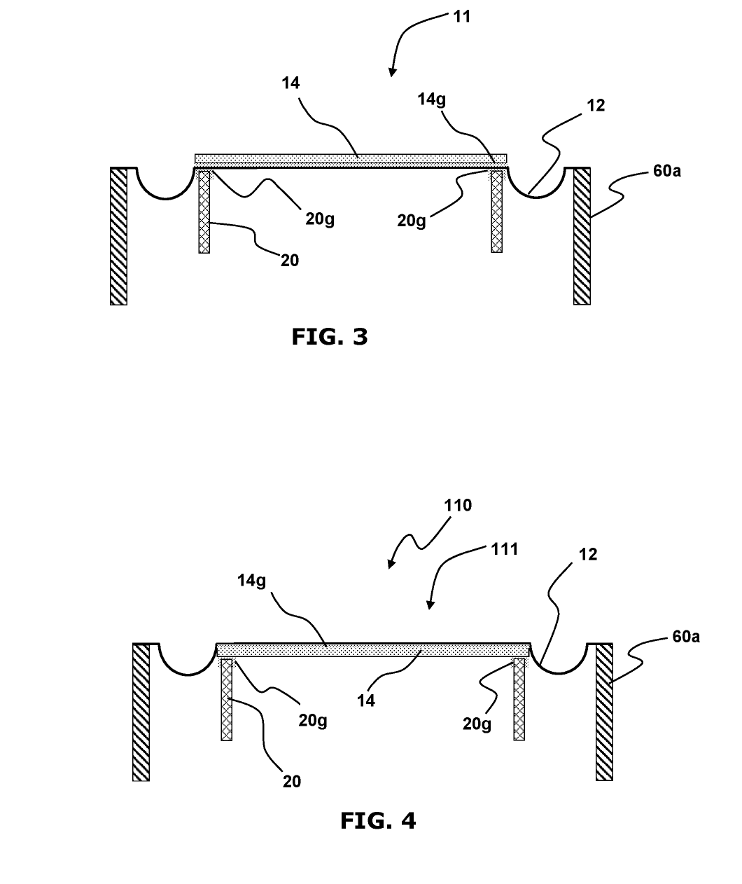

With reference to the diagram of FIG. 3, a first configuration of an assembly stack 11 is described. Proceeding from the bottom to the top of assembly stack 11, coil 20 is adhered to membrane 12 using a coil fixation material or adhesive 20g. Adhesive 20g is used to ensure a proper adhesion of coil 20 to membrane 12. Additionally, the position of adhesive 20g in relation to coil 20 is important. For example, the thickness and width of the contour of the glue has an influence upon the output of the speaker in the ultrasonic range. The properties of adhesive 20g are used for final acoustic tuning of speaker 10. Adhesive 20g may be glue, tape, or other adhesives known in the art. In various embodiments, for example, adhesive 20g may be a glue such as an ultraviolet (UV) and light curing acrylic adhesive. Suitable glues, for example, include but are not limited to, DELO-PHOTOBOND® UB4086 or AD492 adhesives produced by DELO Adhesives. In other embodiments, for example, adhesive 20g may include double-sided tape. A suitable double-sided tape, for example, is tesa® 68559 transparent double-sided self-adhesive tape having a thickness of 20 μm and a composition of 4.5 μm layer of acrylic, an 8 μm layer of PET, and a 4.5 μm layer of acrylic produced by tesa SE. Other suitable double-sided adhesives, for example, include but are not limited to, tesa® 68556 produced by tesa SE and 6653 or 9019 produced by 3M. The total thickness and composition of the double-sided adhesive is used to adjust final acoustic behavior of speaker 10. In yet other embodiments, for example, adhesive 20g may include a heat activated film, such as HAF 58471 produced by tesa SE.

Continuing upward on assembly stack 11 and with continued reference to FIG. 3, membrane 12 may be built out of one or more layers of material. In various embodiments, for example, membrane 12 may be a mono-material or single layer such as a thermoplastic elastomer (TPE). In other embodiments, for example, membrane 12 may be a two layer laminate having a layer of Polyethereetherketone (PEEK) and a layer of thermoplastic polyurethane (TPU), wherein the PEEK material is a hard material in relation to the softer TPU material (i.e., layers of hard—soft material). In yet other embodiments, for example, membrane 12 may be a three layer laminate having a first layer of polyarylate (PAR) (for example, sold under the brand name ARYPHAN® by LOFO High Tech Film GmbH), a second layer of acrylate, and a third layer of PAR, wherein the PAR material is a hard material in relation to the softer acrylate material (i.e., layers of hard—soft—hard material). In addition to these, other suitable materials known in the art may be used for membrane 12.

Membrane 12 is then adhered to plate 14 using a plate fixation material or adhesive 14g. Adhesive 14g is used to ensure a proper adhesion of plate 14 to membrane 12. . The properties of adhesive 14g are used for final acoustic tuning of speaker 10. Adhesive 14g may be glue, tape, or other adhesives known in the art. In various embodiments, for example, adhesive 14g may be a glue such as an ultraviolet (UV) and light curing acrylic adhesive. Suitable glues, for example, include but are not limited to, DELO-PHOTOBOND® UB4086 or AD492 adhesives produced by DELO Adhesives. In other embodiments, for example, adhesive 14g may include double-sided tape. A suitable double-sided tape, for example, is tesa® 68559 transparent double-sided self-adhesive tape having a thickness of 20 μm and a composition of 4.5 μm layer of acrylic, an 8 μm layer of PET, and a 4.5 μm layer of acrylic produced by tesa SE. Other suitable double-sided adhesives, for example, include but are not limited to, tesa® 68556 produced by tesa SE and 6653 or 9019 produced by 3M. The total thickness and composition of the double-sided adhesive is used to adjust final acoustic behavior of speaker 10. In yet other embodiments, for example, adhesive 14g may include a heat activated film, such as HAF 58471 produced by tesa SE. Accordingly, in various embodiments, adhesive 14g and adhesive 20g may be the same but are not required to be the same.

At the top of assembly stack 11 is plate 14. As stated above, plate 14 stiffens membrane 12 increasing its resonant frequency and increasing the frequency response of speaker 10 in the ultrasonic range. This enables speaker 10 to provide useful output in the ultrasonic range. Plate 14 may be built out of one or more layers of material. In various embodiments, for example, plate 14 may be made of a mono-material or single layer of stiff material, including but not limited to, polyethylene naphthalate (PEN), beryllium, aluminum, or other stiff plastics or metals known in the art. Selection of the material can be made based on the stiffness of the material and the desired frequency response in the human-audible acoustic range and the ultrasonic range. In other embodiments, for example, plate 14 may be a multi-layer laminate, such as a laminate comprising layers of PEN and aluminum or layers of foam and aluminum. Such a foam may be a PMI foam like Rohacell from company Evonik, but can also be any other appropriate foam. In yet other embodiments, for example, plate 14 may be a three layer laminate, such as having a first layer of aluminum, a second layer of foam, and a third layer of aluminum, such that the foam is sandwiched between the layers of aluminum. In such embodiments incorporating layers of aluminum and foam, an adhesive may be used to assist in obtaining sufficient adhesion between the aluminum layer(s) and the foam layer. It will be understood that materials other than aluminum, including but not limited to beryllium, other metals, or other plastics may be also be used without departing from the scope of the disclosure. In yet other embodiments, for example, plate 14 may be an asymmetric three layer laminate, such as having a first layer of PAR, a second layer of acrylate, and a third layer of PEN, wherein the thickness of the first layer is about 10 μm, the thickness of the second layer is about 20 μm, and the thickness of the third layer is about 20 μm. It will be understood that materials other than PAR, acrylate, or PEN may be used without departing from the scope of the disclosure.

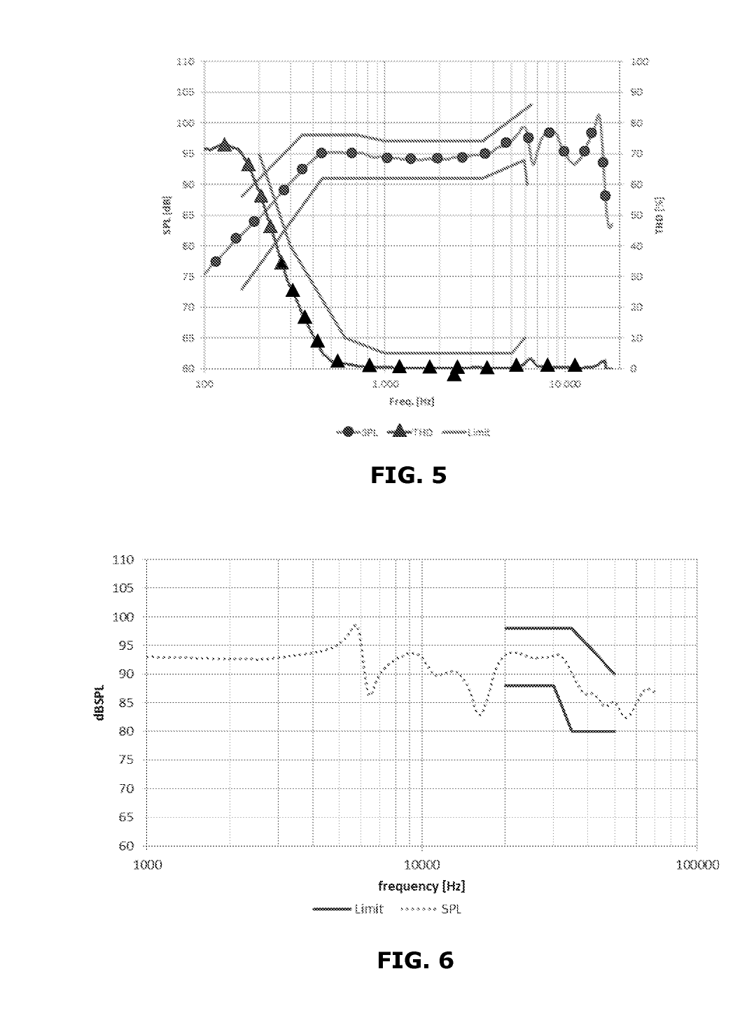

This assembly stack 11 is then assembled into speaker 10 and has a frequency response in the human-audible acoustic range as shown in FIG. 5 and a frequency response in the ultrasonic range as shown in FIG. 6. As can be seen in FIG. 5, an example of speaker 10 provides a nearly uniform frequency response of approximately 95 dB from about 400 Hz to about 4000 Hz with minimal total harmonic distortion (THD) across the same range. As can be seen in FIG. 6, an example of speaker 10 further provides a frequency response or sound pressure level of between 90 and 95 dB between 20 kHz and 30 kHz (within the ultrasonic range). Thus, speaker 10 further provides a frequency response or sound pressure level above about 88 dB between 20 kHz and 30 kHz. To create the frequency response in the ultrasonic range, the following test was performed: (96 h) 6 Vp (141 mW); Signal: log sine sweep 20 kHz-48 kHz, 50 ms, 150 ms silence, 9 dB total crest. Speaker 10 may emit a sound pressure level between the target levels as shown in Table 1 below:

TABLE 1
Ultrasonic Tolerance Window

| f | Lower target | Upper target |
|---|---|---|
| [Hz] | [dB SPL] | [dB SPL] |
| 20000 | 88 | 98 |
| 30000 | 88 | 98 |
| 35000 | 80 | 98 |
| 50000 | 80 | 90 |

Another embodiment of an assembly stack 111 for use in a speaker 110 of the disclosure is illustrated in FIG. 4 and is described below. Some features of one or more of assembly stack 111 and speaker 110 and assembly stack 11 and speaker 10, respectively, are common to one another and, accordingly, descriptions of such features in one embodiment should be understood to apply to other embodiments. Furthermore, particular characteristics and aspects of one embodiment may be used in combination with, or instead of, particular characteristics and aspects of another embodiment.

In particular, assembly stack 111 of speaker 110 comprises membrane 12, plate 14 and coil 20. Membrane 12, plate 14, coil 20, and adhesives 20g, 14g of assembly stack 11 may be identical to membrane 12, plate 14, coil 20, and adhesives 20g, 14g of assembly stack 111. Accordingly, the differences between assembly stack 111 and assembly stack 11 are in the arrangement of the stack. Proceeding from the bottom to the top of assembly stack 111, coil 20 is adhered to plate 14 using a coil fixation material or adhesive 20g. Plate 14 is adhered to membrane 12 using a plate fixation material or adhesive 14g. Thus, the main structural differences between assembly stack 111 and assembly stack 11 are: (1) that plate 14 is below membrane 12 in assembly stack 111 instead of above membrane 12 as in assembly stack 11; and (2) coil 20 is adhered to plate 14 in assembly stack 111 instead of to membrane 12 as in assembly stack 11. By adhering plate 14 to coil 20 the rigidity of assembly stack 111 may be increased as compared to assembly stack 11 which may increase the frequency response in the ultrasonic range. This increased rigidity and increased frequency response may be desired in certain situations.

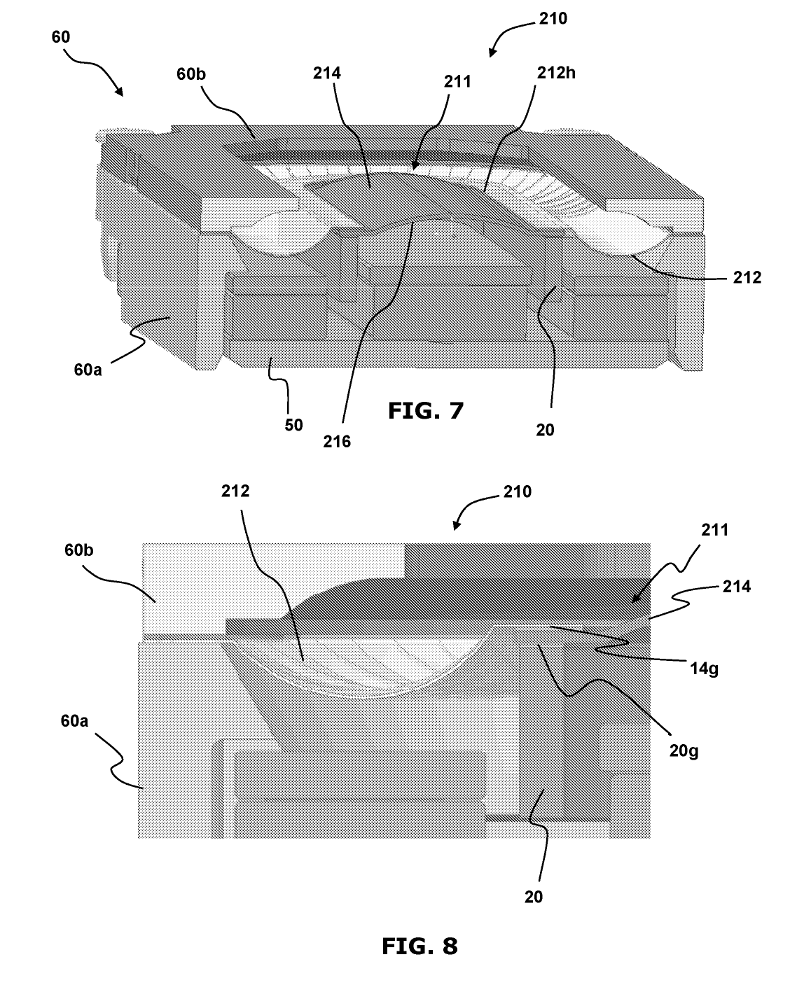

Another embodiment of a speaker 210 and an assembly stack 211 for use therein of the disclosure is illustrated in FIGS. 7 and 8 and is described below. Some features of one or more of assembly stack 211 and speaker 210 and assembly stack 11 and speaker 10, respectively, are common to one another and, accordingly, descriptions of such features in one embodiment should be understood to apply to other embodiments. Furthermore, particular characteristics and aspects of one embodiment may be used in combination with, or instead of, particular characteristics and aspects of another embodiment.

FIGS. 7 and 8 show views of the relevant parts of an electrodynamic transducer or micro speaker 210 which includes an ultrasonic mode. Speaker 210 comprises a membrane 212, a plate 214, and a coil 20. An electrical signal to drive coil 20 in both the human-audible acoustic range, as well as the ultrasonic acoustic range is fed into coil 20 through leads (not shown). Speaker 210 includes a magnet system 50 into which coil 20 is arranged in the assembled speaker 210. Speaker 210 further includes basket or membrane carrier 60 to assemble and align membrane 212 with a magnet system 50. In various embodiments, basket or membrane carrier 60 may include a bottom carrier portion 60a and a top carrier portion 60b. Magnet system 50 includes a base plate and a population of magnets and plates as described with respect to the embodiment in FIG. 1. Coil 20 fits into an air gap of magnet system 50 and is able to translate up and down within the air gap according to the electrical signal fed into coil 20 through leads.

Membrane 212, plate 214 and coil 20 are assembled in an assembly stack 211 in such a configuration to permit emission of sound waves from speaker 210 in the audible and ultrasonic ranges. As will be shown and described, various configurations of the assembly stack can be utilized.

With reference to FIG. 8, a first configuration of assembly stack 211 is described. Proceeding from the bottom to the top of assembly stack 211, coil 20 is adhered to plate 214 using a coil fixation material or adhesive 20g, as described above. Plate 214 is adhered to membrane 212 using a plate fixation material or adhesive 14g, as described above.

Membrane 212 is the same as membrane 12, except that membrane 212 includes a cut out, hole or aperture 212h in the central portion of membrane 212. Aperture 212h may be approximately the same shape as coil 20 and dimensioned slightly smaller than the inside of coil 20. Therefore, unlike assembly stacks 11 and 111 where membrane 12 is coextensive with and completely overlaps or underlaps plate 14, plate 214 and membrane 212 of assembly stack 211 only partially overlap. As shown in FIGS. 7 and 8, plate 214 is located within aperture 212h and partially overlapped by membrane 212. Membrane 212 is adhered to plate 214 at the partially overlapped portion.

Like membrane 12, membrane 212 may be built out of one or more layers of material. In various embodiments, for example, membrane 212 may be a mono-material or single layer such as a thermoplastic elastomer (TPE). In other embodiments, for example, membrane 212 may be a two layer laminate having a layer of Polyethereetherketone (PEEK) and a layer of thermoplastic polyurethane (TPU), wherein the PEEK material is a hard material in relation to the softer TPU material (i.e., layers of hard—soft material). In yet other embodiments, for example, membrane 212 may be a three layer laminate having a first layer of polyarylate (PAR) (for example, sold under the brand name ARYPHAN® by LOFO High Tech Film GmbH), a second layer of acrylate, and a third layer of PAR, wherein the PAR material is a hard material in relation to the softer acrylate material (i.e., layers of hard—soft—hard material). In addition to these, other suitable materials known in the art may be used for membrane 212.

With continued reference to FIGS. 7 and 8, unlike plate 14 of assembly stacks 11 and 111, plate 214 includes additional features to increase the structural rigidity of plate 214 as compared to the flat plate 14. Such structural rigidity increasing elements, may include, for example, domed portion 216. Domed portion 216 increases the structural rigidity of plate 214 and also raises the natural frequency of plate 214 as compared to plate 14. That is, flat plate 14 has a much lower natural frequency than plate 214 with domed portion 216. With this increased natural frequency, the frequency response of speaker 210 in the ultrasonic range may be amplified as compared to speaker 10. This is because the natural frequency (fₙ) (or a higher order resonant frequency or mode) of plate 214 may be in the ultrasonic range. Therefore, when the electrical signal input into coil 20 causes membrane 212 to oscillate at a frequency in the ultrasonic range (fᵤₛ), this frequency (fᵤₛ) may be substantially equal to or equal to the natural frequency (fₙ), or a higher order resonant frequency or mode of plate 214 which causes the amplitude or displacement of the vibration of plate 214 to increase.

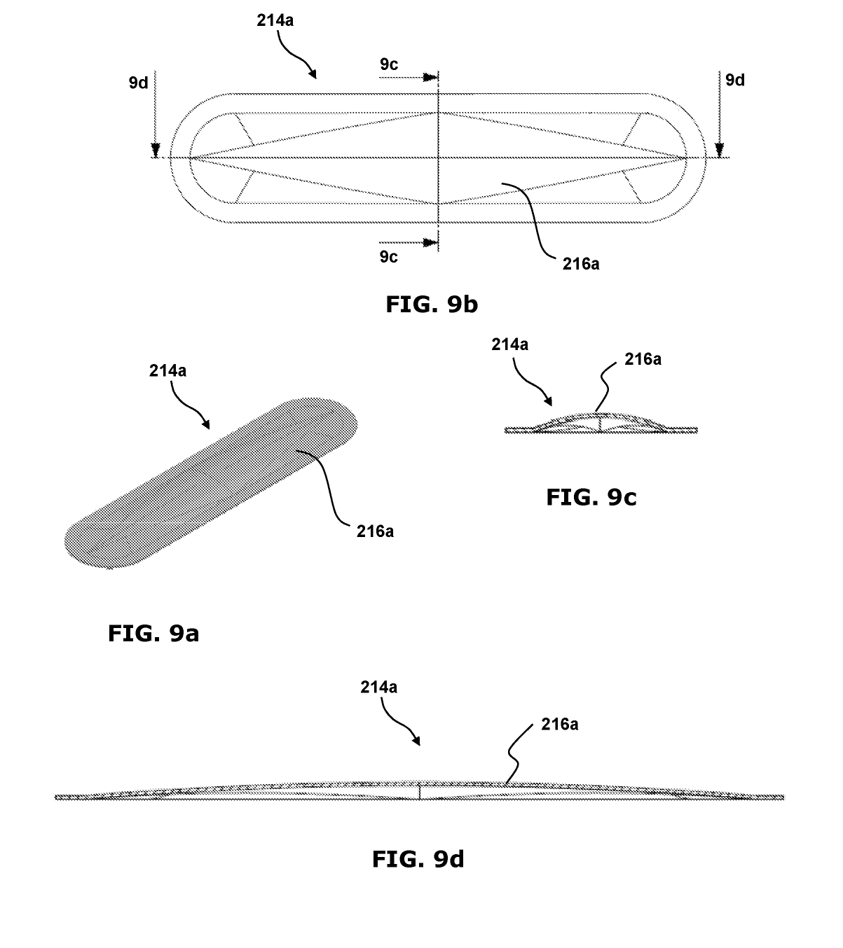

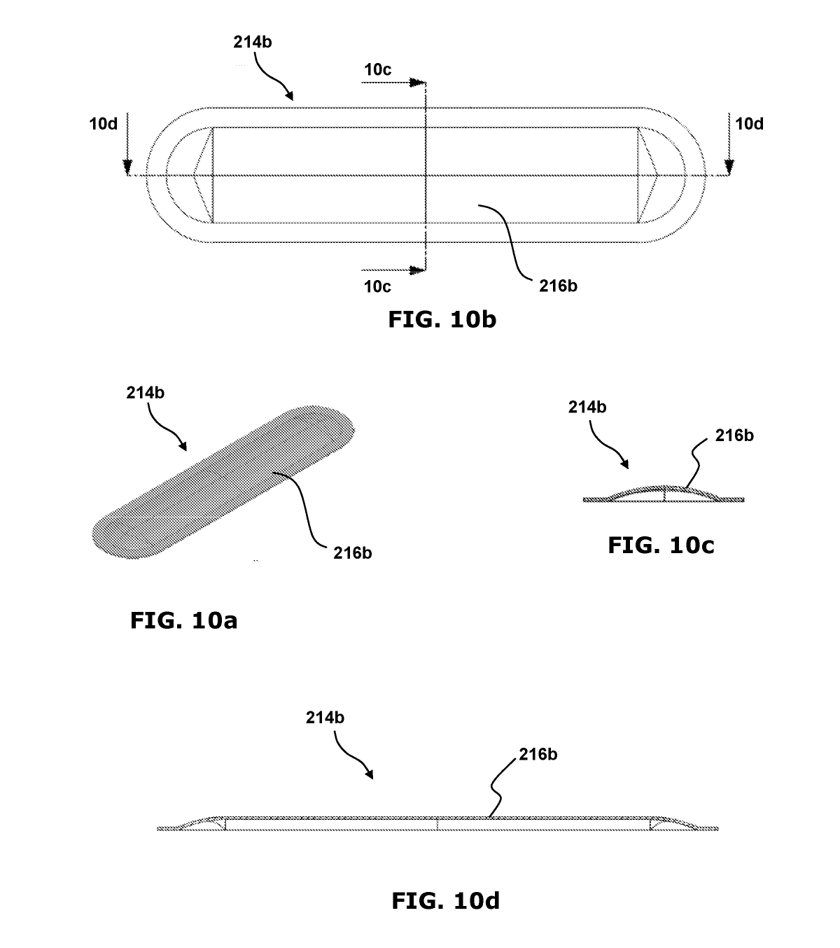

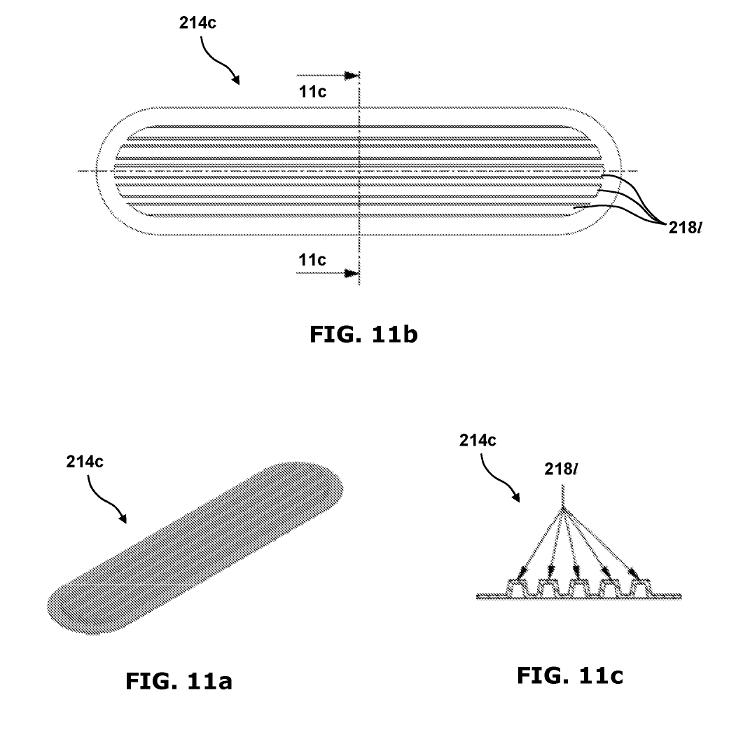

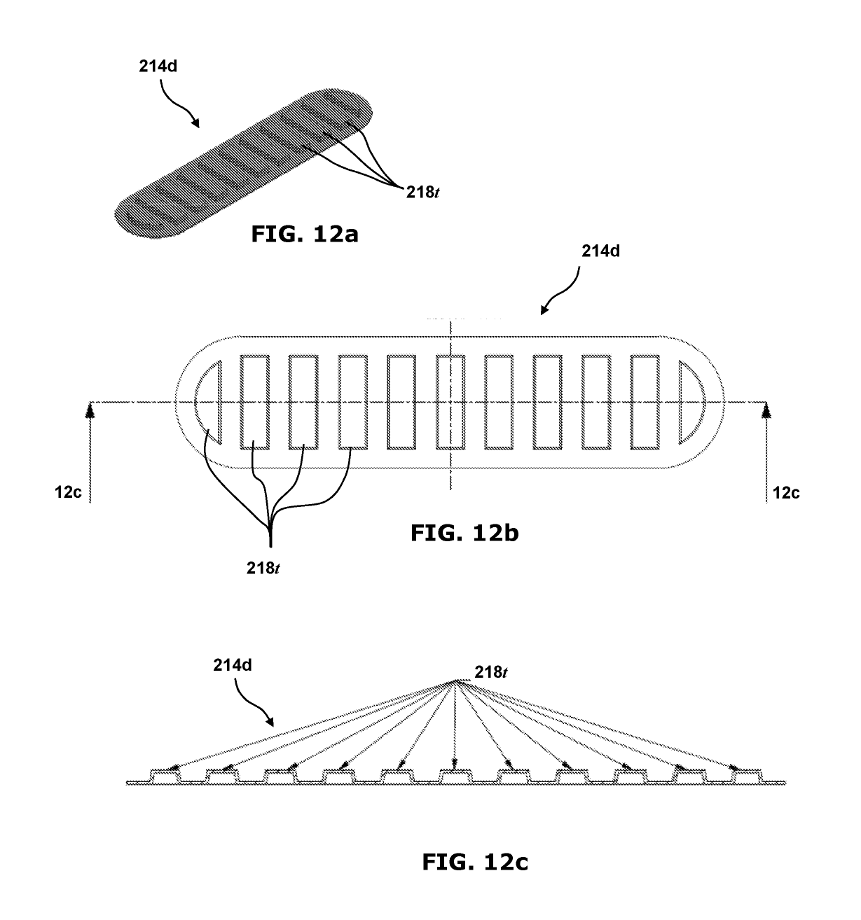

While plate 214 may include domed portion 216 to increase the natural frequency, a variety of alternative structural rigidity increasing elements may be incorporated into plate 214 to increase the natural frequency thereof and improve the frequency response in the ultrasonic range. For example, as shown in FIGS. 9a through 9d, in various embodiments, plate 214a may include an ellipsoid shaped domed portion 216a. In other embodiments, for example, as shown in FIGS. 10a through 10d, plate 214b may include a torus shaped domed portion 216b. In yet other embodiments, for example, as shown in FIGS. 11a through 11c, plate 214c may include a population of longitudinal ribs 218l extending parallel along the length of plate 214c. In yet other embodiments, for example, as shown in FIGS. 12a through 12c, plate 214d may include a population of transverse ribs 218t extending orthogonal to the length of plate 214d. Each of these structural designs increase the natural frequency of plate 214 and aid in improving the frequency response of speaker 210 in the ultrasonic range.

As with plate 14 described above, plate 214 may be built out of one or more layers of material. In various embodiments, for example, plate 214 may be made of a mono-material or single layer of stiff material, including but not limited to, polyethylene naphthalate (PEN), beryllium, aluminum, or other stiff plastics or metals known in the art. Selection of the material can be made based on the stiffness of the material and the desired frequency response in the human-audible acoustic range and the ultrasonic range. In other embodiments, for example, plate 214 may be a two layer laminate, such as a laminate comprising layers of PEN and aluminum or layers of foam and aluminum. Such a foam may be a PMI foam like Rohacell from company Evonik, but can also be any other appropriate foam. In yet other embodiments, for example, plate 214 may be a three layer laminate, such as having a first layer of aluminum, a second layer of foam, and a third layer of aluminum, such that the foam is sandwiched between the layers of aluminum. In such embodiments incorporating layers of aluminum and foam, an adhesive may be used to assist in obtaining sufficient adhesion between the aluminum layer(s) and the foam layer. It will be understood that materials other than aluminum, including but not limited to beryllium, other metals, or other plastics may be also be used without departing from the scope of the disclosure. In yet other embodiments, for example, plate 214 may be an asymmetric three layer laminate, such as having a first layer of PAR, a second layer of acrylate, and a third layer of PEN, wherein the thickness of the first layer is about 10 μm, the thickness of the second layer is about 20 μm, and the thickness of the third layer is about 20 μm. It will be understood that materials other than PAR, acrylate, or PEN may be used without departing from the scope of the disclosure.

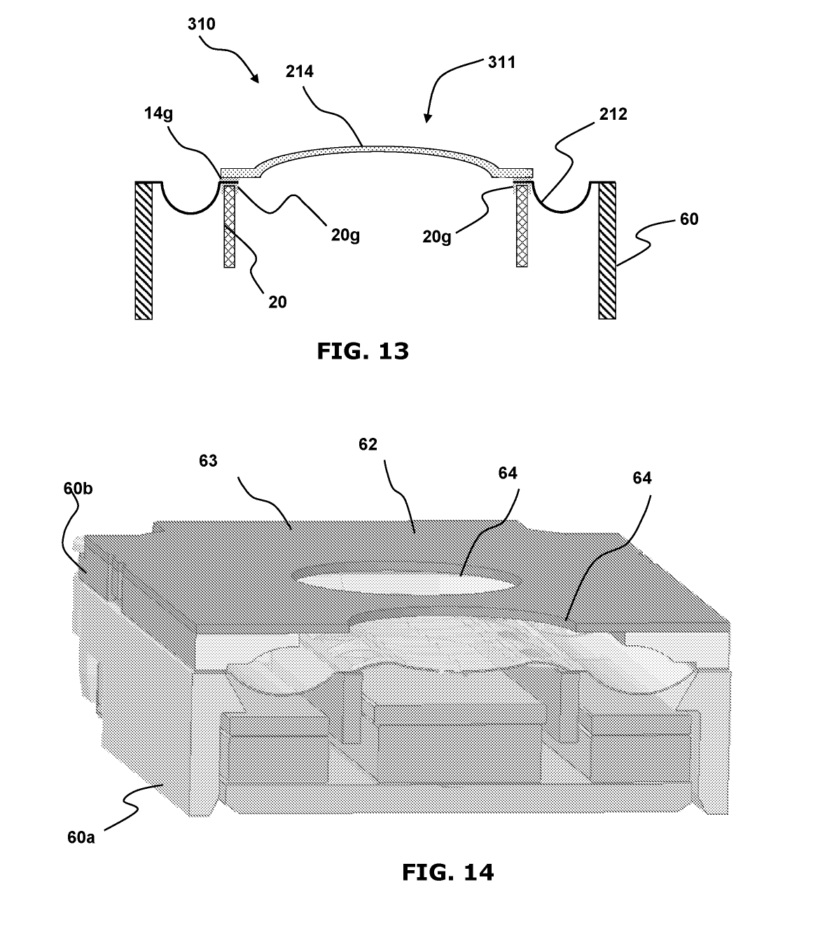

Another embodiment of a speaker 310 and an assembly stack 311 for use therein of the disclosure is illustrated in FIG. 13 and is described below. Some features of one or more of assembly stack 311 and speaker 310 and assembly stack 211 and speaker 210, respectively, are common to one another and, accordingly, descriptions of such features in one embodiment should be understood to apply to other embodiments. Furthermore, particular characteristics and aspects of one embodiment may be used in combination with, or instead of, particular characteristics and aspects of another embodiment.

In particular, assembly stack 311 of speaker 310 comprises membrane 212, plate 214 and coil 20. Membrane 212, plate 214, coil 20, and adhesives 20 g, 14 g of assembly stack 311 may be identical to membrane 212, plate 214, coil 20, and adhesives 20 g, 14 g of assembly stack 211. Accordingly, the differences between assembly stack 311 and assembly stack 211 are in the arrangement of the stack. Proceeding from the bottom to the top of assembly stack 311, coil 20 is adhered to membrane 212 using a coil fixation material or adhesive 20 g. Plate 214 is adhered to membrane 212 using a plate fixation material or adhesive 14 g. Thus, the main structural differences between assembly stack 311 and assembly stack 211 are: (1) that plate 214 is above membrane 212 in assembly stack 311 instead of below membrane 212 as in assembly stack 211; and (2) coil 20 is adhered to membrane 212 in assembly stack 311 instead of to plate 214 as in assembly stack 211.

Now with reference to FIG. 14, a front resonator 62 which may be used with any of the above described speakers 10, 110, 210, 310 is described. In various embodiments, front resonator 62 may be affixed to top carrier portion 60b of speakers 10, 110, 210, 310 when speakers 10, 110, 210, 310 are installed in a final product. Front resonator 62 is a major parameter in fine tuning speakers 10, 110, 210, 310 and is located above membrane 12, 112, 212, 312. Front resonator 62 comprises a panel 63 having a population of holes 64 extending there through. The number, shape, size and location of holes 64 may be selected and/or altered based on the desired final tuning or acoustical performance of speakers 10, 110, 210, 310. For example, in various embodiments, front resonator 62 may include only 1 hole or 10 holes, or any number of holes there between. In various embodiments, front resonator 62 may include more than 10 holes. FIG. 14 represents a cross-section of a front resonator 62 having three (3) circular holes 64, with only one and one-half holes shown. While circular holes 64 are shown, it will be understood that other hole shapes may be used, including but not limited to, triangular, square, rectangular, ovular, pentagonal, hexagonal, octagonal, etc. without departing from the scope of the disclosure.

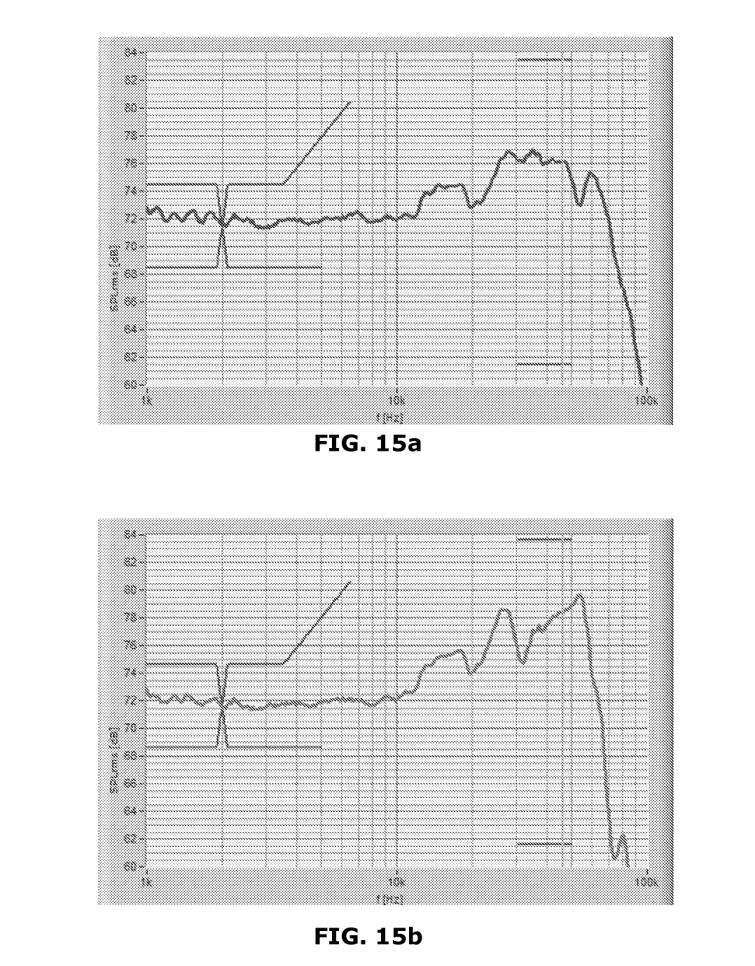

The effect on the final tuning or acoustic performance of front resonator 62 on speakers 10, 110, 210, 310 is illustrated in the SPL graphs of FIGS. 15a and 15b. FIG. 15a is representative of a speaker 10, 110, 210, 310 without front resonator 62. As can be seen, a speaker 10, 110, 210, 310 itself shows a rather smooth boost in the frequency response or sound pressure level (SPL) in the ultrasonic range. FIG. 15b is representative of a speaker 10, 110, 210, 310 with front resonator 62 and in a final product with housing including the front volume (not shown). This is known as the basic field of optimization, which is the area in front of the membrane, which includes the front volume as well as holes 64 and/or slits in front resonator 62 to the outer world. As shown in FIG. 15b, the resonant peak of a speaker 10, 110, 210, 310 is tuned to be in the ultrasonic range. The frequency response or SPL is increased in the ultrasonic range with the inclusion of front resonator 62. For example, as shown in FIG. 15b, the SPL at the resonant frequency of about 55 kHz is between about 79 and 80 dB. Thus final tuning of the resonant peak and SPL at that peak may be controlled by front resonator 62 and/or final packaging of speakers 10, 110, 210, 310.

Another embodiment of a speaker 410 and an assembly stack 411 for use therein of the disclosure is illustrated in FIG. 17 and is described below. Some features of one or more of assembly stack 411 and speaker 410 and assembly stacks 11, 111, 211, and 311 and speakers 10, 110, 210, and 310 respectively, are common to one another and, accordingly, descriptions of such features in one embodiment should be understood to apply to other embodiments. Furthermore, particular characteristics and aspects of one embodiment may be used in combination with, or instead of, particular characteristics and aspects of another embodiment.

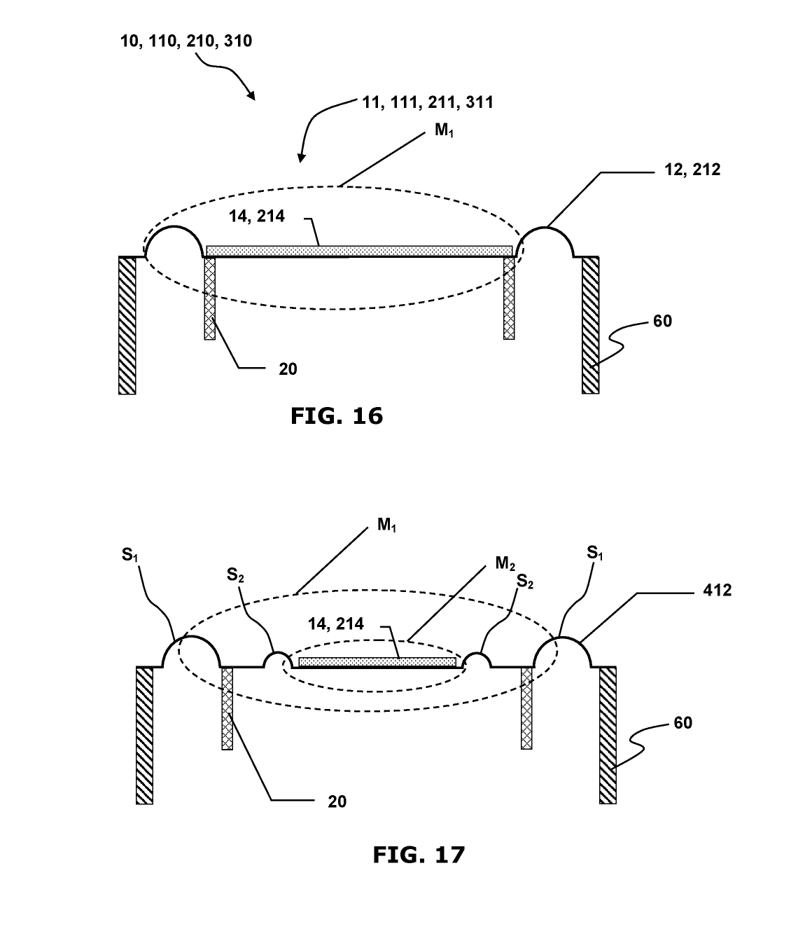

In particular, assembly stack 411 of speaker 410 comprises membrane 412, plate 414 and coil 20. Membrane 412, plate 414, coil 20, and adhesives (not shown) of assembly stack 411 may be identical to membrane 12, 212, plate 14, 214, coil 20, and adhesives 20 g, 14 g of assembly stack 11, 111, 211, 311. Whereas assembly stacks 11, 111, 211, 311 can be considered single degree of freedom (1-DOF) spring-mass systems (see FIG. 16), assembly stack 411 is a two degree of freedom (2-DOF) spring-mass system. That is, assembly stack 411 includes two springs (S₁, S₂) and two masses (M₁, M₂). Membrane 412 comprises first and second springs (S1, S2), wherein the first spring S₁ is located between basket 60 and coil 20 and the second spring S₂ is located inside coil 20. Coil 20 and the non-spring portions of membrane 412 comprise the first mass M₁ and plate 414 and the non-spring portions of membrane 412 attached to plate 414 comprise the second mass M₂. The first spring S₁ has a first spring constant k₁, and the second spring S₂ has a second spring constant k₂.

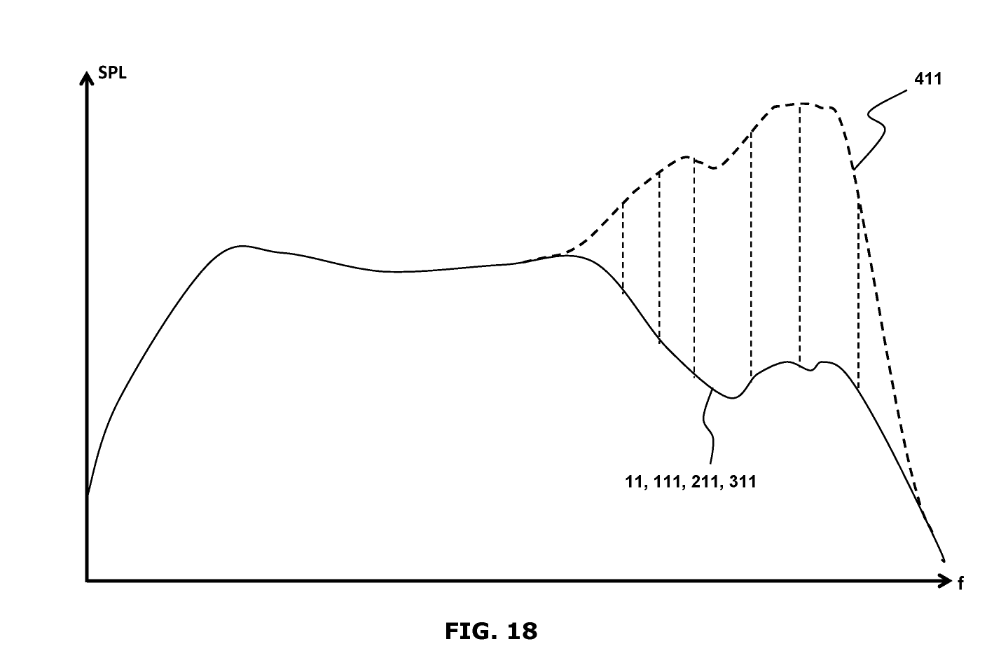

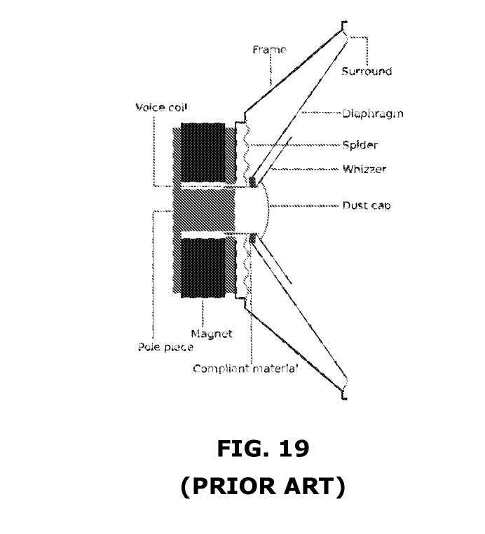

Assembly stack 411 will therefore have two dominant modes or resonant frequencies. The first mode or resonant frequency is where the first and second masses M₁, M₂ move in phase with each other. The second, higher mode or resonant frequency is where the first and second masses M₁ , M₂ move out of phase with each other. The masses and spring constants can be selected to achieve an increased frequency response in the ultrasonic range as shown in FIG. 18 as compared to a 1-DOF frequency response. The simulated frequency response of the 2-DOF assembly stack 411 is shown with an increased response at the higher frequencies (see dashed lines), whereas the simulated frequency response for the 1-DOF assembly stack 11, 111, 211, 311 are shown in solid lines. In many ways, the second mass M₂ and the second spring S₂ act like a whizzer of a typical prior art hi-fi speaker (as shown in FIG. 19) to increase the frequency response in the higher frequencies.

It will be understood that in various embodiments, for example, plate 414 of assembly stack 411 may have a domed portion as is described above with respect to plate 214. This may further aid in increasing the frequency response of assembly stack 411 in the ultrasonic range.

While an electrodynamic transducer that may generate a sound pressure level in the human-audible acoustic range and the ultrasonic range is described, it will be understood that the electrodynamic transducer described herein may be implemented in any type of acoustic device, wherein the term “acoustic device” particularly denotes any apparatus which is capable of generating sound for emission to an environment and/or for the detection of sound present in the environment. Such an acoustic device particularly includes any electromechanical transducer, electrodynamic loudspeaker, or piezoelectric transducer capable of generating acoustic waves based on electrical signals, or vice versa. For example, membranes produced from the membrane precursors described herein may be used in a loudspeaker and a microphone.

In closing, it should be noted that the invention is not limited to the above mentioned embodiments and exemplary working examples. Further developments, modifications and combinations are also within the scope of the patent claims and are placed in the possession of the person skilled in the art from the above disclosure. Accordingly, the techniques and structures described and illustrated herein should be understood to be illustrative and exemplary, and not limiting upon the scope of the present invention. The scope of the present invention is defined by the appended claims, including known equivalents and unforeseeable equivalents at the time of filing of this application.

What is claimed is:

1. An electrodynamic transducer, comprising:
a coil;
a membrane; and
a plate, wherein the electrodynamic transducer is adapted to generate a sound pressure level in the human-audible acoustic range and the ultrasonic range.

2. The electrodynamic transducer of claim 1, wherein the electrodynamic transducer is adapted to generate a sound pressure level above about 88 dB between 20 kHz and 70 kHz.

3. The electrodynamic transducer of claim 1, wherein the electrodynamic transducer is adapted to generate a sound pressure level of between about 90 dB and 95 dB between 20 kHz and 70 kHz.

4. The electrodynamic transducer of claim 1, wherein the coil is adhered to the membrane, and the membrane is adhered to the plate.

5. The electrodynamic transducer of claim 4, further comprising:
a coil fixation material for adhering the coil to the membrane; and
a plate fixation material for adhering the membrane to the plate.

6. The electrodynamic transducer of claim 5, wherein the coil fixation material is a glue, double-sided tape, or heat activated film.

7. The electrodynamic transducer of claim 5, wherein the plate fixation material is a glue, double-sided tape, or heat activated film.

8. The electrodynamic transducer of claim 1, wherein the coil is adhered to the plate, and the plate is adhered to the membrane.

9. The electrodynamic transducer of claim 8, further comprising:
a coil fixation material for adhering the coil to the plate; and
a plate fixation material for adhering the plate to the membrane.

10. The electrodynamic transducer of claim 9, wherein the coil fixation material is a glue, double-sided tape, or heat activated film.

11. The electrodynamic transducer of claim 9, wherein the plate fixation material is a glue, double-sided tape, or heat activated film.

12. The electrodynamic transducer of claim 1, wherein the plate comprises a structural rigidity increasing feature.

13. The electrodynamic transducer of claim 12, wherein the structural rigidity increasing feature comprises a domed portion or a population of ribs.

14. The electrodynamic transducer of claim 1, further comprising a front resonator having one or more holes extending through the resonator, wherein the front resonator is adapted to increase the sound pressure level of the electrodynamic transducer in the ultrasonic range.

15. An electrodynamic transducer comprising:
a coil;
a plate comprising a structural rigidity increasing feature; and
a membrane comprising an aperture within which the plate is located, and wherein the membrane and the plate partially overlap, and wherein the membrane and plate are adhered to one another at the partial overlap;
wherein the electrodynamic transducer is adapted to generate a sound pressure level in the human-audible acoustic range and the ultrasonic range.

16. The electrodynamic transducer of claim 15, wherein the structural rigidity increasing feature comprises a domed portion or a population of ribs.

17. The electrodynamic transducer of claim 15, wherein the electrodynamic transducer is adapted to generate a sound pressure level above about 88 dB between 20 kHz and 70 kHz.

18. The electrodynamic transducer of claim 15, wherein the electrodynamic transducer is adapted to generate a sound pressure level of between about 90 dB and 95 dB between 20 kHz and 70 kHz.

19. The electrodynamic transducer of claim 15, further comprising a front resonator having one or more holes extending through the resonator, wherein the front resonator is adapted to increase the sound pressure level of the electrodynamic transducer in the ultrasonic range.

20. An electrodynamic transducer comprising:
a coil;
a plate adhered to the coil, the plate comprising a structural rigidity increasing feature; and
a membrane comprising an aperture within which the plate is located, and wherein the membrane partially overlaps the plate and wherein the membrane and plate are adhered to one another at the partial overlap;
wherein the electrodynamic transducer is adapted to generate a sound pressure level in the human-audible acoustic range and the ultrasonic range.
